(19) United States
(12) Patent Application Publication
(10) Pub. No.: US 2010/0070100 A1
(43) Pub. Date: Mar. 18, 2010

(54) CONTROL ARCHITECTURE AND SYSTEM FOR WIRELESS SENSING

(76) Inventors: Jan F. Finlinson, Lindon, UT (US); Martin R. Johnson, Draper, UT (US); Jeremy P. Willden, Pleasant Grove, UT (US)

Correspondence Address: ANGUS C. FOX, III, 4093 N. IMPERIAL WAY, PROVO, UT, 84604-5386, US

(21) Appl. No.: 12/560,419

(22) Filed: Sep. 15, 2009

Related U.S. Application Data
(60) Provisional application No. 61/096,884, filed on Sep. 15, 2008.

(51) Int. Cl. G06F 1/28; G06F 1/26

(52) U.S. Cl. 700/295

(57) ABSTRACT

A wireless control system includes at least one remote actuator unit (RAU) and at least one local sensor units (LSU) or self-powered, wireless sensor (SPWS), and may further include a wireless commissioning system (WCS), which enables associations between devices to be established from a single location. The LSUs, RAUs, and SPWSs are each programmed to operate in harmony with one another by creating associations between each other, each being identifiable by the others using a unique identification number. This association can be accomplished using programming buttons on each type of unit. Alternatively, the associations between devices within a wireless controlled system can be greatly simplified using the WCS. Establishing associations between the various devices permits the devices to interact with each other. The absence of an association between devices prevents the devices from interacting with one another. Each device can be associated with zero, one, or multiple other devices.

This application has a priority date based on Provisional Patent Application No. 61/096,884, which has a filing date of Sep. 15, 2008, and is titled CONTROL ARCHITECTURE AND SYSTEM FOR WIRELESS SENSING.

### BACKGROUND OF THE INVENTION

1. Field of the Invention

The present invention relates generally, to electrical control systems. More specifically, the invention relates to wireless systems for controlling items such as motors found in HVAC systems or water supply and distribution systems, machines found in factories, and light fixtures found in and around buildings or dwellings.

2. History of the Prior Art

It is commonly difficult, costly and/or impractical to install wires between existing controlled electrical systems/circuits and new controlled electrical device(s). The level of difficulty and/or impracticality may be attributable to the need to damage or demolish ceilings, floors, or walls, and to excavate parking lots, driveways or roads. Labor costs for installing new wiring can be considerable. This is particularly true if a team of electricians is required to perform the job.

As a wireless alternative to installing new wiring does not suffer from the aforesaid disadvantages, such an alternative may be advantageous if the utility of the wired and wireless solutions are substantially equivalent. In fact, a wireless control system may confer additional capability and/or convenience compared to hard-wired systems. Various methods and/or systems have been proposed, which attempt to overcome some of the difficulties/impracticalities mentioned above (see reference patents). Unfortunately, these methods fall short of addressing the wide variety of circumstances which may be encountered when designing, installing, deploying, and commissioning such systems. Moreover, they do not allow for flexibility in connecting to or interfacing with other systems. Further, they are restricted to specific applications or installation scenarios. Further still, their system architectures do not allow the system to be easily scaled up or down, as system needs evolve or change. In fact, they may even require ongoing maintenance, much of which can be eliminated.

### SUMMARY OF THE INVENTION

A wireless control system includes at least one remote actuator unit (RAU) and at least one local sensor units (LSU) or self-powered, wireless sensor (SPWS), and may further include a wireless commissioning system (WCS), which enables associations between devices to be established from a single location.

The LSUs, RAUs, and SPWSs are each programmed to operate in harmony with one another by creating associations between each other, each being identifiable by the others using a unique identification number. This association can be accomplished using programming buttons on each type of unit. Alternatively, the associations between devices within a wireless controlled system can be greatly simplified using the WCS. Establishing associations between the various devices permits the devices to interact with each other. The absence of an association between devices prevents the devices from interacting with one another. Devices have be ability to be associated with zero, one, or multiple other devices.

Multiple local sensor units (LSUs) and multiple remote actuator units (RAUs) can be incorporated in a single control system so that many control operations can be performed wirelessly by having certain devices within that system transmit radio signals containing control commands, which are received and acted upon by other devices in the system. Because of the flexibility that the present invention offers, it is possible and practical, and easy to add additional or new control input variables to existing controlled electrical systems/circuits.

Because of the usefulness and scalability of this invention, it has a broad scope of applications. For one application, there may be a single local sensor unit (LSU) and a single remote actuator unit (RAU) operating together in a small wireless control network. For another application, there could be a single LSU, several RAUs, and several self-powered, wireless sensors (SPWSs). For yet another application, there may be hundreds, or even thousands, of LSUs, RAUs, SPWSs, operating together in a large-scale wireless control network.

On one hand, setting up or configuring or reconfiguring small networks, is most easily accomplished by directly, or manually, interacting with the individual components. On the other hand, setting up or configuring large networks through such direct, manual interaction can be cumbersome or impossible. Thus, an automated tool and method for setting up, configuring and reconfiguring large networks is advantageous or even necessary. The wireless commissioning system (WCS) is designed to facilitate the commissioning of large networks easily and efficiently. The WCS is useful or essential, particularly if there are a large number of nodes in the system or if gaining physical access to the any of the nodes is difficult.

A source of electrical power is typically available at the controlled location, which source of power can be used to provide power to the RAU and possibly the new controlled device. The RAU can easily be connected, with conductors, to the power source.

In addition, an electrical power source is also typically available at the location where the existing controlled circuit/system resides. The source of power can be used to provide power to the LSU, by connecting the LSU, with conductors, to the power source.

Furthermore, it is common to have access to the signals or circuits, which control the existing controlled circuit or system. These signals or circuits can be coupled to the LSU, with conductors. The LSU, in turn, extends the effect of the control signal to one or more RAUs, each of which has been programmed to respond to the LSU.

In many instances, it is also desirable to add additional control elements to existing systems, without the requirement of also adding additional wiring. SPWSs that are compatible with the other system components, operating as part of the network, make this possible.

It is convenient for the new controlled device to provide feedback to the controlling system as to its status. This feedback provides the control system and/or the user, with information that may be vital to correct system operation if, for example, a wireless signal either were not received or were misread due to interference.

It is convenient to allow local control at the new controlled device and also allow remote control of the new device from the existing controlled system. Clearly, the LSU at location A, can control an RAU, at location B. In some instances, it is advantageous to control the RAU from location C. For example, an operator at location C may want to override the control signal coming from location A. The SPWS would allow such type of functionality to take place.

In electrical control systems, it is common for wires to terminate in junction boxes, or wiring panels, which provide convenient access to wiring connections therein. The LSU and the RAU and some SPWS are designed to mount inside or alongside such junction boxes or wiring panels, allowing them to be easily and inexpensively interfaced with the conductors in the box or panel.

### BRIEF DESCRIPTION OF THE DRAWINGS

FIG. 1 is a schematic diagram of an electrical circuit having a power source, a load, and a switch;

FIG. 2 is a schematic diagram of an electrical circuit having a power source, a load, a switch, and a control system which controls the switch;

FIG. 3 is schematic of three wirelessly-coupled circuits, the first of which transmits a switch command to a pair of receiving circuits;

FIG. 4 is a schematic of a pair of wirelessly-coupled circuits, both of which employ tranceivers for the sending and receipt of commands and for the sharing of feedback information;

FIG. 5 is a schematic of a circuit having a manual three-way switch, a four-way switch, a radio-controlled three-way switch, and a load in series with an electrical power source;

FIG. 6 is a drawing which shows the wireless interaction of an energy harvesting sensor and a local sensor unit with an energy harvesting actuator and a remote actuator;

FIG. 7 is a simple circuit having a switch leg;

FIG. 8 is a modification of the circuit of FIG. 7, where the switch leg has been replaced with a radio link;

FIG. 9 depicts a pair of circuits which are coupled via a relay;

FIG. 10 depicts a pair of circuits coupled with a wireless radio link;

FIG. 11 is a diagram showing a remote actuator unit (RAU) and an associated receiver mounted on an electrical junction box;

FIG. 12 is schematic showing a local sensor unit (LSU) and an associated transmitter (TX) mounted within a first electrical junction box, a remote actuator unit (RAU) and associated receiver (RX) mounted within a second electrical junction box, and a self-powered wireless sensor, with the RAU being wirelessly coupled to the other two units;

FIG. 13 shows at least one autonomous self-powered wireless sensor, at least one local sensor unit coupled to an associated existing controlled system, at least one remote actuator unit coupled to a pair of power supplies and a new electrical load, and a wireless commissioning system for establishing and coordinating relationships between the various other components;

FIG. 14 shows the interaction of a single transmitter or transceiver with a wirelessly-linked single receiver or other transceiver;

FIG. 15 shows the interaction of a single transmitter or transceiver with wirelessly-linked multiple receivers or other transceivers;

FIG. 16 shows the interaction of multiple transmitters or transceivers with a wirelessly-linked single receiver or other transceiver;

FIG. 17 shows the interaction of multiple transmitters or transceivers with wirelessly-linked multiple receivers or other transceivers;

FIG. 18 is a block diagram of an electrical system in which a load coupled to a remote actuator unit is wireless controlled by a local sensor unit and a pair of self-powered wireless sensors;

FIG. 19 is a block diagram of an electrical system in which four loads, each coupled to a remote actuator unit, are controlled by a four-channel local sensor unit, as well as by a self-powered wireless sensor;

FIG. 20 is a block diagram of an electrical system having a wireless commissioning system, and in which four fans are wirelessly controlled by a pair of local sensor units and a self-powered wireless sensor;

FIG. 21 is a block diagram of an electrical system in which overload protection is provided to an electrical generator via a wireless link between a local sensor unit and a remote actuator unit;

FIG. 22 is a block diagram of an electrical system in which a heating, ventilation, and air-conditioning system is disabled by a wireless link between a local sensor unit and a remote actuator unit when an existing lighting circuit is switched off; and

FIG. 23 is a block diagram of an electrical system in which a dimmable LED fixture connected to a remote actuator unit is wirelessly controlled by self-powered wireless sensors and a four-channel local sensor unit, and directly controlled by a momentary contact switch and a photoelectric sensor.

### DETAILED DESCRIPTION OF THE PREFERRED EMBODIMENT(S)

In accordance with the present invention, a local sensor unit (LSU) includes: one or more inputs feeding sensors; a connection to an external power source; a power supply; one or more programming buttons; one or more indicators; and at least one item that is both selected from the group consisting of wireless transmitters, wireless transceivers and wireless receivers. The LSU is connected to an existing controlled electrical system or circuit. For instance, the LSU can be connected in parallel with an existing load, can replace an existing load, or can be connected as a new load in a circuit. The LSU wirelessly transmits control signals under at least one of the following conditions: when the local existing electrical system/circuit is activated; occasionally, while the local existing electrical system/circuit is activated; when the local existing electrical system/circuit is deactivated; occasionally when the control circuit is disabled; when the local existing condition, which it is sensing, changes; when the local existing conditions, which it is sensing, change; when a combination of local existing conditions, which it is sensing, meet pre-defined criteria; never or occasionally, while the local existing condition(s), which it is sensing, remain unchanged; when it forced to do so by a user; and according to a pre-determined schedule, which could be periodic, occasional, random, deterministic, or cyclic. The LSU receives status and/or acknowledgement packets from one or more remote actuator units, is capable of indicating the state of the remote actuator unit, has the ability to repeat or retransmit control signals which it receives, mounts inside or adjacent to an electrical wiring box, such as, but not limited to an electrical junction box, an electrical wiring box, or an electrical wiring panel.

Also, in accordance with the present invention, the remote actuator unit (RAU) includes: a connection to a first external power source; a connection to a second external power source, where the first and second power sources may be one and the same; a connection to an external load; a power supply; programming buttons; and at least one item selected from the group consisting of wireless transmitters, wireless transceivers and wireless receivers; means for modifying the connection between the second external power source and the external load (e.g.: turning on or off; dimming up/down; modulating pulse width (PWM); varying the voltage, current or resistance; performing a soft start, or zero-cross detection). The RAU can be configured to respond to one or more local sensor units and/or one or more self-powered wireless sensor units. Configuration is accomplished using programming buttons and/or the wireless commissioning system (WCS). The RAU receives control signals wirelessly from local sensor units and/or self-powered wireless sensors, and uses the control signal information in the received signals, as well as other information, to decide when the connection between the second external power source and the external load should be modified. The RAU wirelessly transmits status/acknowledgement signals whenever it receives a control signal from a local sensor unit, from an self-powered wireless sensor, or when it determines that it should, based on an internal algorithm, or procedure. The status/acknowledgement signals contain information about the state of the connection between the second external power source and the external load. The RAU has the ability to repeat or retransmit control signals which it receives. The RAU mounts inside or adjacent to an electrical junction box, an electrical wiring box, an electrical wiring panel, or some other similar component.

Further, in accordance with the present invention, the self-powered wireless sensor (SPWS) includes: a wireless receiver, transmitter or transceiver; a local power source, which can be an energy storage device (e.g., a voltaic cell, a battery, a capacitor, or an inductor), an energy-harvesting source (e.g., a photoelectric cell, a piezoelectric cell, a pyroelectric cell, a thermoelectric cell, an electrostatic cell, an electrodynamic cell, an magnetostatic cell, or a magnetodynamic cell) or a combination of energy-harvesting devices and energy storage devices; at least one sensor; means for reading sensor information, means for transmitting or communicating sensor information; and at least one programming button. The SPWS is capable of sensing physical conditions such as temperature, motion, force, humidity, light, sound, pressure and movement. The SPWS wirelessly transmits control signals when either the physical conditions it is sensing change, the physical conditions it is sensing meet pre-defined criteria, never or only occasionally while physical conditions it is sensing remain unchanged, when forced to do so by a user, or according to a pre-determined schedule, which can be periodic, occasional, random, deterministic, or cyclic.

Still further, in accordance with the present invention, the wireless commissioning system (WCS) includes: a wireless transceiver; a computing device such as a personal computer, a personal digital assistant (PDA), a microcontroller device having a buttons and display interface, a microcontroller device having a touch-screen interface, or a microcontroller device having only a button interface; and a software application that allows the user to identify, query, and program the other wireless devices over the wireless interface. The software application permits a user to create associations between local sensor units and remote actuator units, so that they respond to each other. The software application also has an ability to store the IDs of the LSUs, RAUs, and SPWSs, thereby allowing association to be made between the devices without requiring the user to gain physical access to any of those devices. IDs can be stored on a fixed or removable disk drive, in flash memory, or on a removable storage device. The software application also has the ability to set and store authentication information, such as passwords and/or encryption keys required to access the LSUs, RAUs, SPWSs, thereby securing the system against unauthorized, malicious, unintentional, inadvertent activities, or tampering. The software application also provides feedback to the user locally (at the WCS) or remotely (LSU, RAU, SPWS) to indicate that associations are either ready or prepared or about to take place, are in the process of taking place, have taken place successfully, or did not take place successfully.

The following is a list of devices and terms that, from the perspective of the present invention, should be considered equivalent: self-powered, battery-powered, energy-harvesting, internally-powered, and battery-free; associated, bound, memorized, programmed, and stored; memory, non-volatile memory, flash, flash memory, and solid-state memory; disk-drive, drive, disk, and storage device; microcontroller, microprocessor, computing device, and computer; and junction box, box, wiring box, wiring panel, j-box, extension ring, wiring enclosure, enclosure.

The invention will now be described in greater detail with reference to the attached drawing figures.

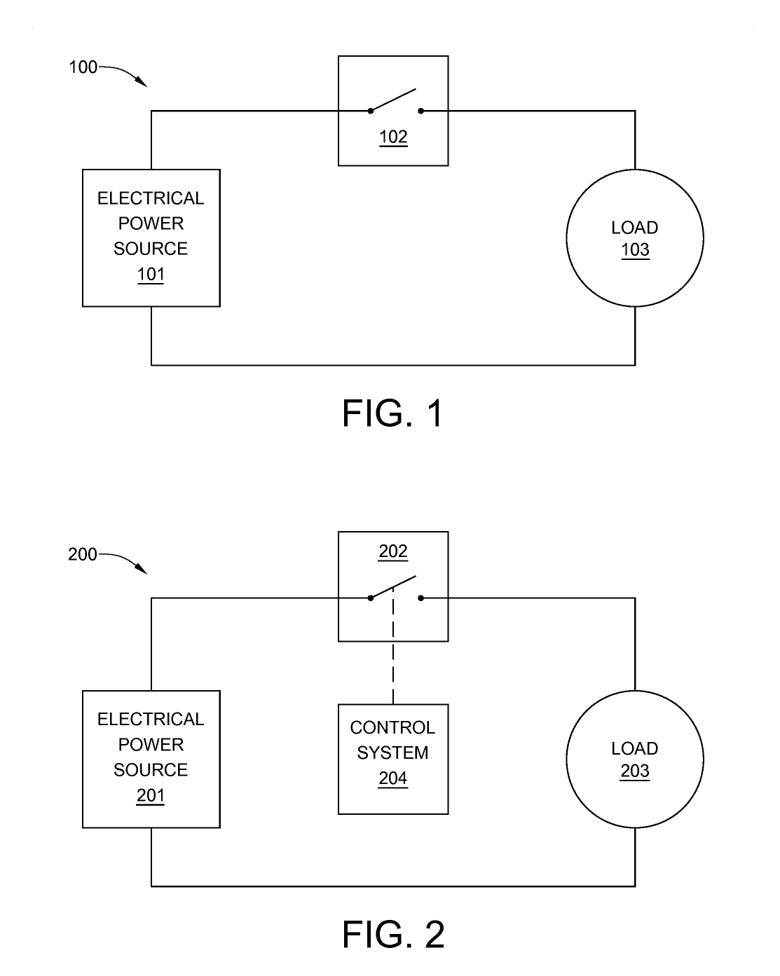

Referring now to FIG. 1, a first electrical circuit 100 is shown wherein an electrical power source 101, a manual switch 102, and a load 103 are all connected in series.

Referring now to FIG. 2, a second electrical circuit 200 is shown wherein an electrical power source 201, a system-controlled switch 202, and a load 203 are all connected in series. The system-controlled switch 202 is shown coupled to a control system 204, which actuates the former. The control system 204 may directly control the switch 202 so that it is urged between ON and OFF states, or the switch may be of either a NORMALLY ON or NORMALLY OFF type, and the control system causes the switch 202 to revert to the opposite state and maintain that opposite state for a period determined by the system.

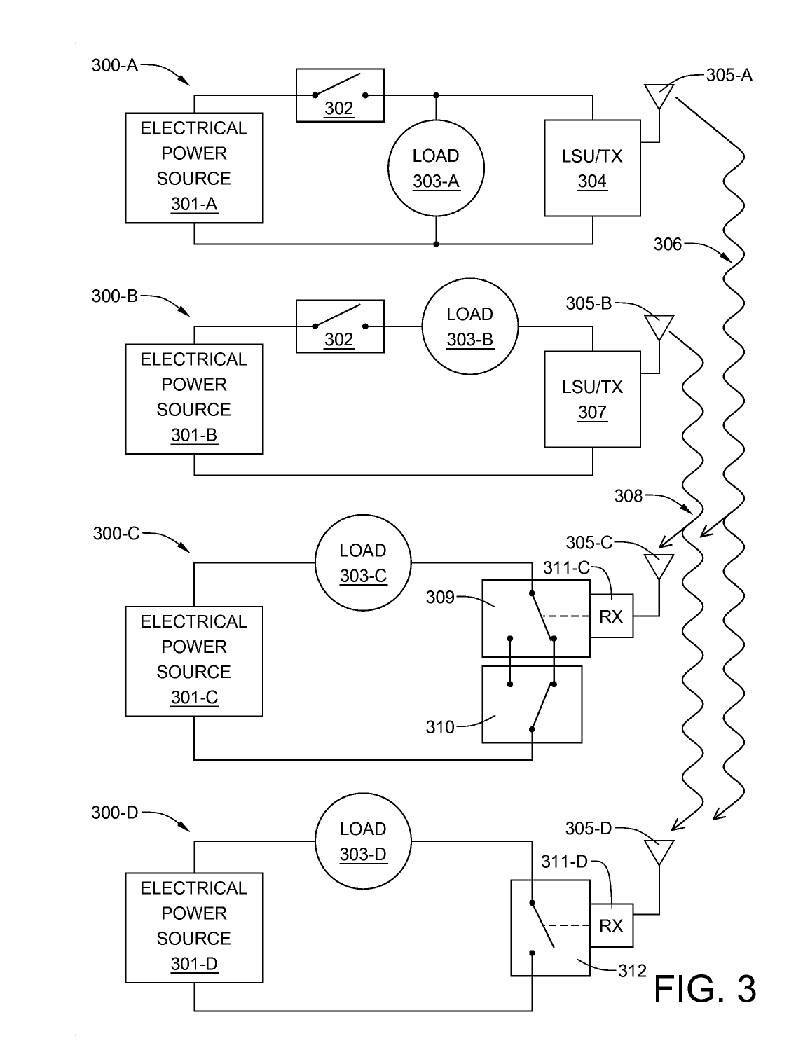

Referring now to FIG. 3, electrical circuitS 300-A and 300-B are wirelessly coupled to electrical circuits 300-C and 300-D. In circuit 300-A, a load 303-A and a local sensor unit having a transmitter (LSU/TX) 304 are connected in parallel with an electrical power source 301-A when a manual switch 302 is turned ON. When the switch 302 is ON, the LSU/TX 304 transmits an electromagnetic signal 306 from antenna 305-A. Electromagnetic signal 306 is received by both antenna 305-C of receiver 310-C and antenna 305-D of receiver 310-D. In circuit 300-B, a load 303-B and a local sensor unit having a transmitter (LSU/TX) 307 are connected in series with an electrical power source 301-B when a manual switch 302 is turned ON. When the switch 302 is ON, the LSU/TX 307 transmits an electromagnetic signal 308 from antenna 305-A. Electromagnetic signal 308 is received by both antenna 305-C of receiver 311-C and antenna 305-D of receiver 311-D. In circuit 300-C, a load 303-C, a radio-controlled three-way switch 309, and a manual three-way switch 310 are all coupled in series with an electrical power source 301-C. Radio-controlled three-way switch 309 changes positions in response to electromagnetic signals 306 or 308, which are received by receiver 311-C. Using the manual three-way switch 310, power to the load 303-C can be either manually disconnected from electrical power source 301-C or manually reconnected to electrical power source 301-C, depending on the state of the circuit at the time the manual three-way switch 310 is thrown. In circuit 300-D, a single-pole switch 312 is actuated in response to the electromagnetic signals 306 or 308, which is received by receiver 311-D, thereby connecting the load 303-D to the electrical power source 301-D or disconnecting the load 303-D from the electrical power source 301-D.

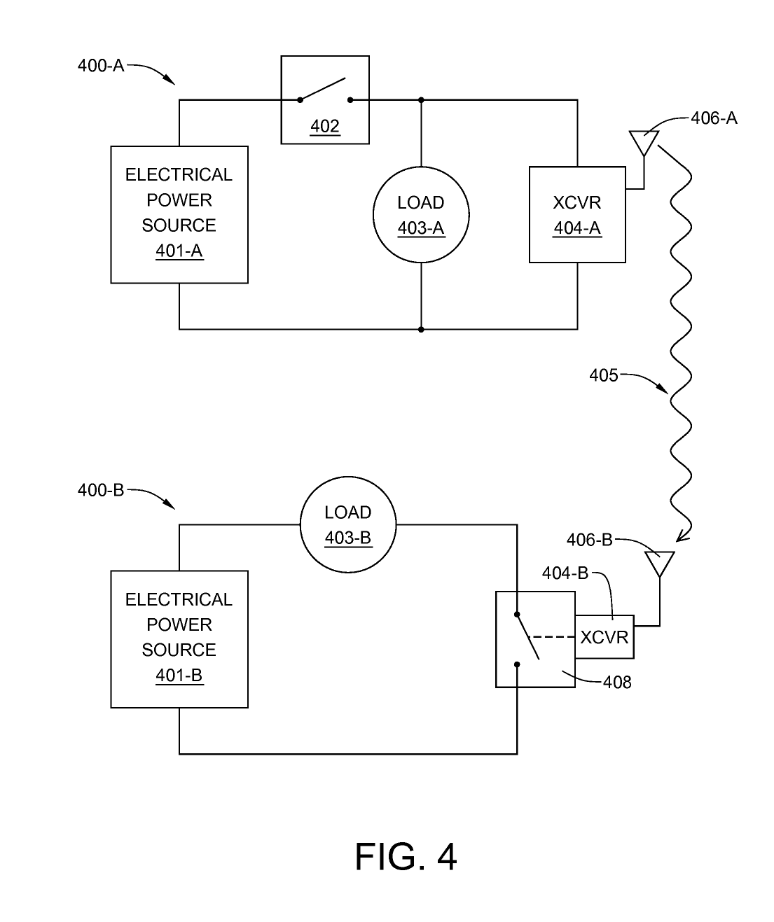

Referring now to FIG. 4, an electrical circuits 400-A and 400-B are wirelessly intercoupled. In circuit 400-A, a load 403-A and a transceiver 404-A are connected in parallel with an electrical power source 401-A when a manual switch 402 is turned ON. When the switch 402 is turned ON, the transceiver 404-A transmits an electromagnetic signal 405 from antenna 406-A. Electromagnetic signal 405 is received by antenna 406-B of transceiver 404-B. In circuit 400-B, a single-pole switch 408 is actuated in response to the electromagnetic signal 405, which is received by transceiver 404-B, thereby connecting the load 403-B to the electrical power source 401-B. These two circuits react similarly to circuits 300-A and 300-C of FIG. 3, with the exception that the transceivers 404-A and 404-B are able to provide feedback to one another.

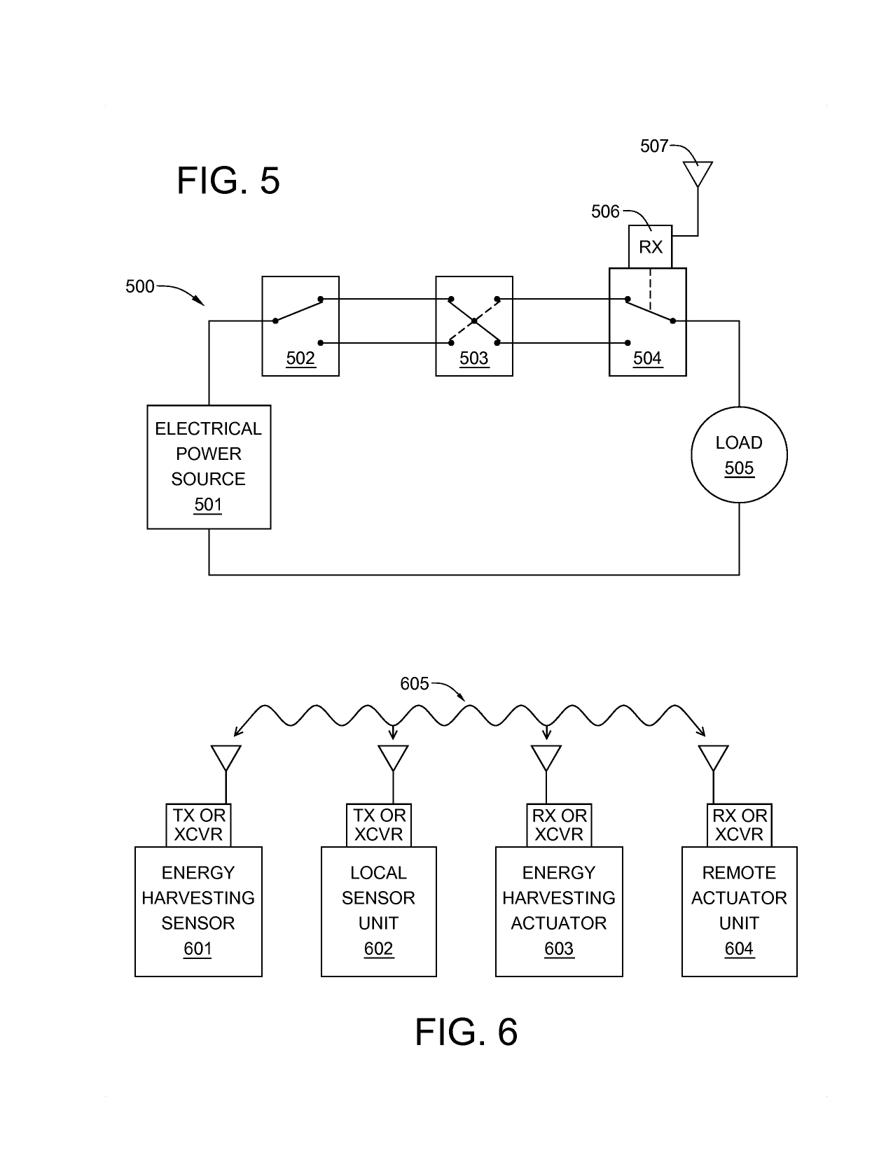

Referring now to FIG. 5, an electrical circuit 500 is shown in which a manual three-way switch 502, a four-way switch 503, a radio-controlled three-way switch 504, and a load 505 are all connected in series with an electrical power source 501. The radio-controlled three-way switch 504 is controlled by radio signals received by receiver 506 through antenna 507.

Referring now to FIG. 6, an energy harvesting sensor 601 or a local sensor unit 602 can wirelessly control either an energy harvesting actuator 603 or a remote actuator unit 604 via radio signals 605. Examples of energy harvesting processes include modulated backscatter common to RFID devices, conversion of light or mechanical energy to electrical energy, self-powered switches, generation of electrical energy from temperature gradients through the use of thermoelectric devices, such as thermocouples or Peltier junctions. The energy harvesting sensor 601 and local sensor unit 602 can each incorporate a transmitter or transceiver with an antenna, while the energy harvesting actuator 603 and remote actuator unit 604 can each be equipped with a receiver or transceiver with an antenna. If the devices all use transceivers, then feedback can be transmitted between them to verify that an operation has occurred, is still occurring, or has ceased.

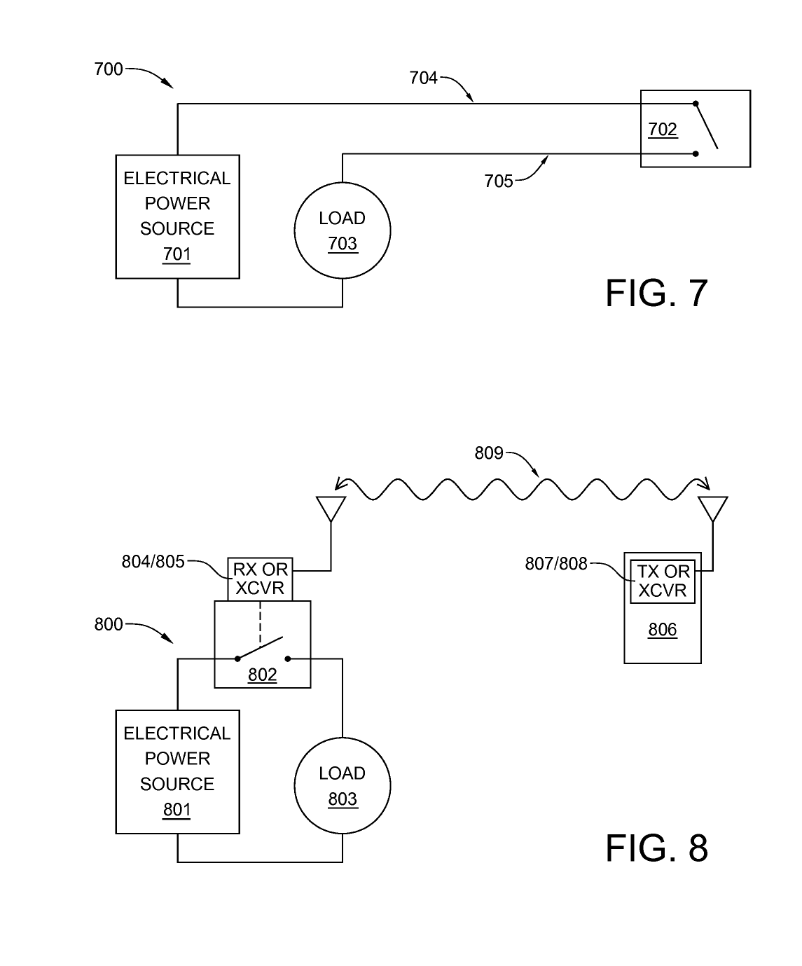

Referring now to FIG. 7, a simple electrical circuit 700 comprises an electrical power source 701, a manual switch 702, and a load 703 in series. In order to switch power to the load ON and OFF, a switch leg including conductors 704 and 705 is required.

Referring now to FIG. 8, an electrical circuit 800 has a power source 801, a radio-controlled switch 802, and a load 803 in series. The switch leg of FIG. 7 has been replaced with the radio-controlled switch 802 having a receiver (RX) 804 or first transceiver (XCVR) 805 and a remote signal unit 806 having a transmitter (TX) 807 or second transceiver (XCVR) 808. The remote signal unit controls the radio-controlled switch 802 over a radio link 809.

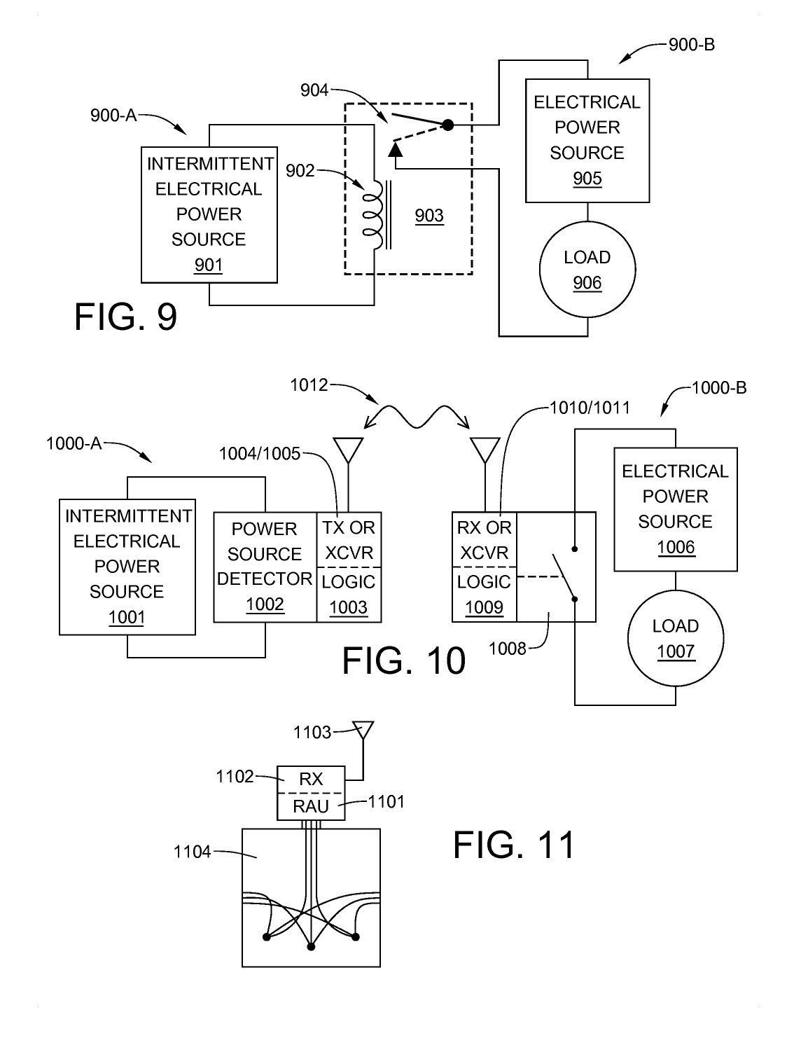

FIG. 9 depicts first and second circuits 900-A and 900-B, respectively. First circuit 900-A includes an intermittent electrical power source 901 and the solenoid 902 of relay 903. Second circuit 900-B includes the contacts 904 of relay 903, an electrical power source 905, and a load 906. The relay 903 is activated whenever current from the intermittent electrical power source 901 flows through the solenoid 902 of relay 903. The load 906 may be a detector which senses when the contacts 904 of relay 903 are closed.

FIG. 10 depicts a first and second circuits 1000-A and 1000-B, respectively. First circuit 1000-A includes an intermittent electrical power source 1001, a power source detector 1002, logic 1003 coupled to the power source detector 1002, and a transmitter (TX) 1004 or a transceiver (XCVR) 1005 with an antenna coupled to the logic 1003. Second circuit 1000-B includes an electrical power source 1006, a load 1007, and a radio-controlled switch 1008, all of which are series coupled. Logic 1009 is coupled to the radio-controlled switch 1008, and a receiver 1010 or transceiver 1011 having an antenna is coupled to the logic 1009. Whenever power source detector 1002 detects current from the intermittent electrical power source 1001, the logic 1003 and transmitter 1004 or transceiver 1005 cooperate to transmit a radio signal 1012 which is received by receiver 1010 or transceiver 1011 and processed by logic 1009, thereby activating or deactivating radio controlled switch 1008. Electrical current can then flow to the load 1007, which can be a detector module or some other powered apparatus. In the circuits 1000-A and 1000-B, the relay 903 of FIG. 9 has been replaced by the wireless radio link 1012. If transceivers 1005 and 1011 are used in place of the transmitter 1004 and receiver 1010, then feedback can be communicated between the two circuits to verify that a sensing operation has been properly detected.

Referring not to FIG. 11, a remote actuator unit (RAU) 1101 and an associated receiver 1102 having an antenna 1103 are mounted on and outside an electrical junction box 1104. Electrical codes may prevent the mounting of low-voltage components within a junction box containing high-voltage connections. This arrangement solves that problem by isolating the low-voltage and high-voltage components.

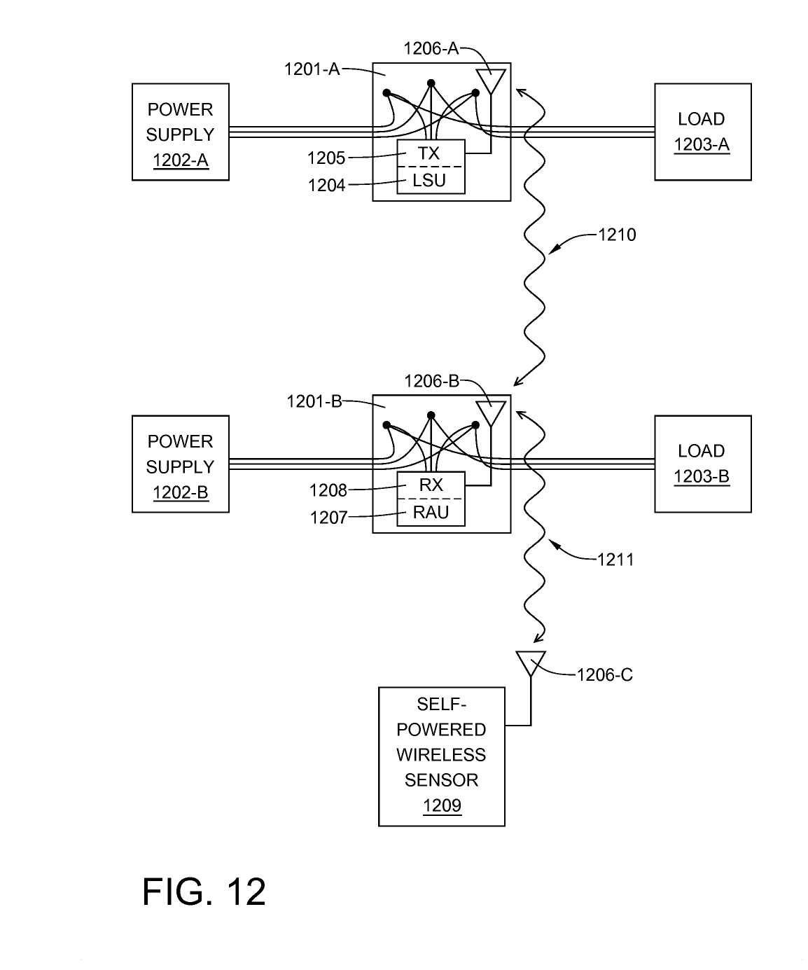

Referring now to FIG. 12, a wireless system comprises three assemblies: a first junction box 1201-A interposed between a first power supply 1202-A and a first load 1203-A, the first junction box 1201-A containing a local sensor unit (LSU) 1204 and an associated transmitter (TX) 1205 with a first antenna 1206-A; a second junction box 1201-B interposed between a second power supply 1202-B and a second load 1203-B, the second junction box containing a remote actuator unit 1207 and an associated receiver (RX) 1208 with a second antenna 1206-B; and a self-powered wireless sensor 1209 having a third antenna 1206-C. The RAU 1207 is wirelessly coupled to both the LSU 1204 and the self-powered wireless sensor 1209 via first and second radio links 1210 and 1211, respectively.

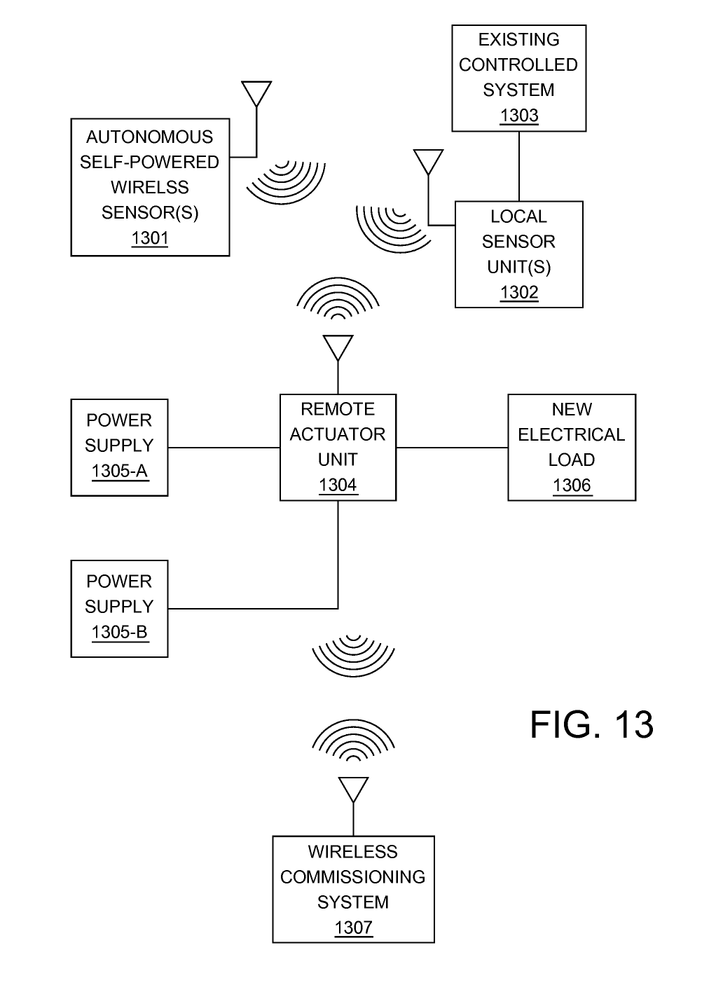

Referring now to FIG. 13, a wireless control system comprises: at least one autonomous self-powered wireless sensor 1301, at least one local sensor unit 1302 coupled to an associated existing controlled system 1303; at least one remote actuator unit 1304 coupled to first and second power supplies 1305-A and 1305-B and to a new electrical load 1306; and a wireless commissioning system 1307 for establishing and coordinating relationships between the various other components. The wireless commissioning system 1307 eliminates the need for visiting remote sites in order to activate remote sensors and actuator units, and further eliminates the need to physically program remote units using buttons or other controls thereon. All commissioning commands may be performed at a single location on a single console or computer that is coupled by radio links to all other components in the system.

The technology disclosed in this application have been incorporated into wireless control products produced by ILLUMRA Corporation. ILLUMRA has become the largest supplier in North America, of self-powered, battery-free, wireless lighting control and energy management systems. ILLUMRA is a division of Ad Hoc Electronics and is member of the EnOcean Alliance. All ILLUMRA products operate using the EnOcean protocol, the De-facto standard for energy-harvesting wireless controls. The technology allows energy harvesting ILLUMRA transmitters to operate indefinitely without the use of batteries. The motion of a switch actuation, light on a solar cell, or other ambient energy in the environment provide power to ILLUMRA transmitters, providing zero-maintenance wireless devices. The ILLUMRA product line includes multiple products which operate in the uncrowded 315 MHz band offering greater transmission range than other wireless technologies and minimal competitive traffic.

The ILLUMRA hybrid control system combines benefits of ZigBee 802.15.4 Industrial Wireless Relays (IWR) from Ad Hoc Electronics with the benefits of EnOcean compatible ILLUMRA Self-powered Wireless Controls. ILLUMRA wireless systems allow users to control electrical loads 150 feet away; the EnOcean+ZigBee hybrid system extends that range up to 1 mile. The system is made up of two component groups: first, an IWR pair designed to provide simple long-range remote control; and second, ILLUMRA battery-free wireless light switches and sensors, which are designed to provide easy-to-install light control and energy management systems. Together, these products make up the ILLUMRA hybrid system which provides simple, customizable, long range wireless light control, security control, pump station control, electronic sign control, traffic control, factory automation, and more. The hybrid system is especially effective for controlling loads across large open spaces where it would be preferable to not run wire. Examples of such applications include: barns, guest-houses, sports stadiums, tennis courts, boat-houses and garages.

The ILLUMRA hybrid system provides wireless remote control up to 1 mile away without the use of repeaters. The hybrid system uses ILLUMRA battery-free wireless light switches to produce a wireless signal. An ILLUMRA Low Voltage Relay Receiver that is connected to an Industrial Wireless Relay picks up the signal; the IWR then broadcasts the signal up to 1 mile away in all horizontal directions. A separate IWR connected to as many as four external relays, each sized for the load, receives the signal and controls attached electrical loads. The hybrid system may be used in 3-way switch applications by connecting ILLUMRA 5-wire Relay Receivers between the external relays and electrical loads.

ILLUMRA's wireless control products are well known in the industry for streamlining the deployment of energy-saving control systems in retrofit installations. In smaller systems, the integrated switch association process—in which associations between individual components are set by programming buttons on the components themselves—is an efficient way to teach receivers to respond to user control switches. As deployments grow in size, however, more powerful tools are available to speed the configuration of the control system. One of these tools is the ILLUMRA wireless commissioning system. The software installs on a desktop or laptop PC and communicates with installed switches and receivers through one or more ILLUMRA wireless adapters, connected to a serial or USB port or over an Ethernet network. Wireless security options are configured by the user, as shown here, and security settings may be downloaded to newly installed devices at any time. Control relays, either added to existing lighting or pre-installed in fixtures or ballasts, do not need to be mapped out in advance. No pre-configuration or installation planning is required, and light fixtures may be installed in any order and at any time. The commissioning system searches for new devices and lists them on the screen. The user selects each listed fixture receiver, connects to it, and turns the light on and off to aid in locating the installed location. Once identified, the user may provide a friendly name for each light, indicating the location or description of the device. For this demonstration, each light is named by row and position within the row. Next the user captures the ID of each switch they want to install. Switches are listed in order, with the most recently captured switch at the top of the list. Again, friendly names are added to each switch for easy identification. In this system, each row of lights will be controlled by a separate rocker switch, with a Master switch to turn all lights on or off. On the Associations page of the software, select each switch and add the receivers. The Master switch has all receivers added to it, while each of the row switches will be associated with just a few lights. After making changes to the Associations page, one click applies the changes to the ILLUMRA network. The switch associations are stored in permanent memory when the software exits. The PC and the ILLUMRA wireless adapter are no longer required at this point, and the network operates autonomously.

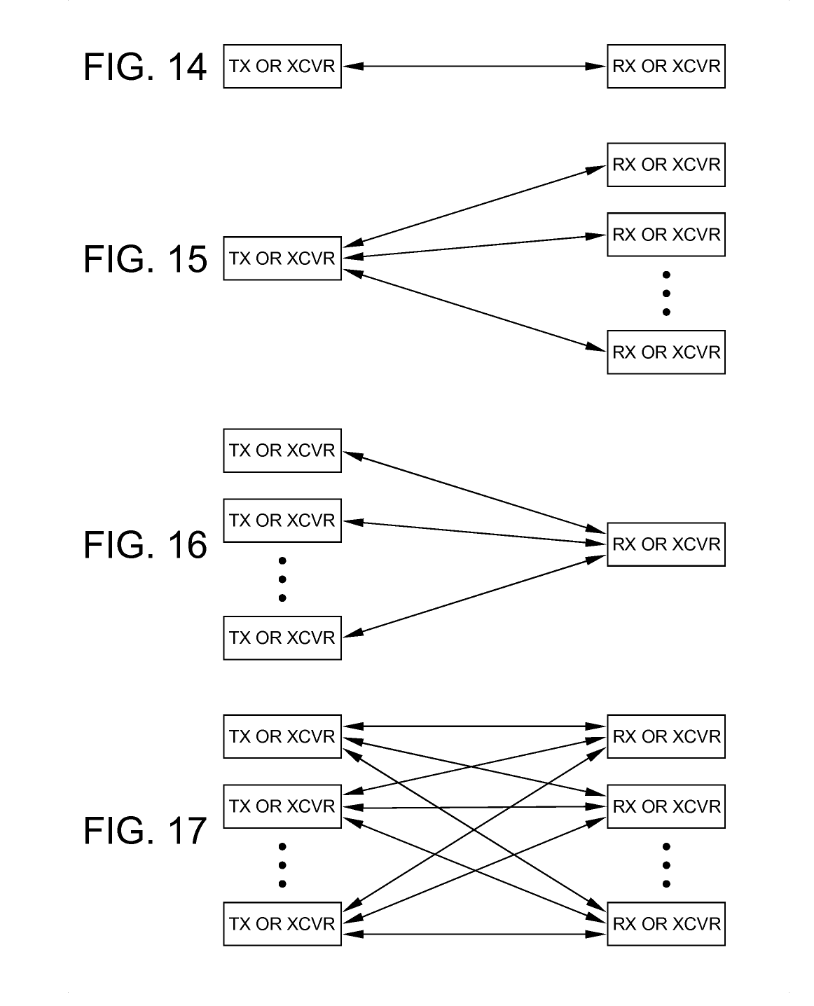

During initial setup, a floorplan of the building to be outfitted may be imported as a background and reference. The commissioning system searches for new devices and lists them on the screen. The user selects each fixture, one at a time. A double-click turns the light on or off to help determine the installed location. Once identified, a name, description, or other information may be added to each load and control point. Next the user captures the ID of each switch they want to install. The most recently captured switch is highlighted for reference. Dual-rocker switches and other multiple button controls are automatically identified. Again, names may be added to each switch for easy identification. In this system, each row of lights will be controlled by a separate rocker switch, with a Master switch to turn all lights on or off. Switches are associated by a simple click and drag. Switches are associated by a simple two click process. Multiple receivers may be associated in one step by selecting a group. The Master switch has all receivers added to it, while each of the row switches will be associated with just a few lights. After making changes to the Associations page, one click applies the changes to the ILLUMRA network. The switch associations are stored in permanent memory when the software exits. The PC and the ILLUMRA wireless adapter are no longer required at this point, and the network operates autonomously. FIGS. 14 through 17 illustrate the possibilities for interaction of various components within a wireless control system.

Referring now to FIG. 14, the interaction of a single transmitter or transceiver with a wirelessly-linked single receiver or other transceiver is depicted.

Referring now to FIG. 15, the interaction of a single transmitter or transceiver with wirelessly-linked multiple receivers or other transceivers is depicted.

Referring now to FIG. 16, the interaction of multiple transmitters or transceivers with a wirelessly-linked single receiver or other transceiver is depicted.

Referring now to FIG. 17, the interaction of multiple transmitters or transceivers with wirelessly-linked multiple receivers or other transceivers is depicted.

Block diagrams of a number of exemplar electrical circuit systems will now be shown and described. The circuit systems combine self-powered wireless sensors (SPWSs), local sensor units (LSUs), remote actuator units (RAUs), and other devices in order to achieve desired functionality which, in all cases, includes wireless control via the transmission of radio-frequency signals between certain components.

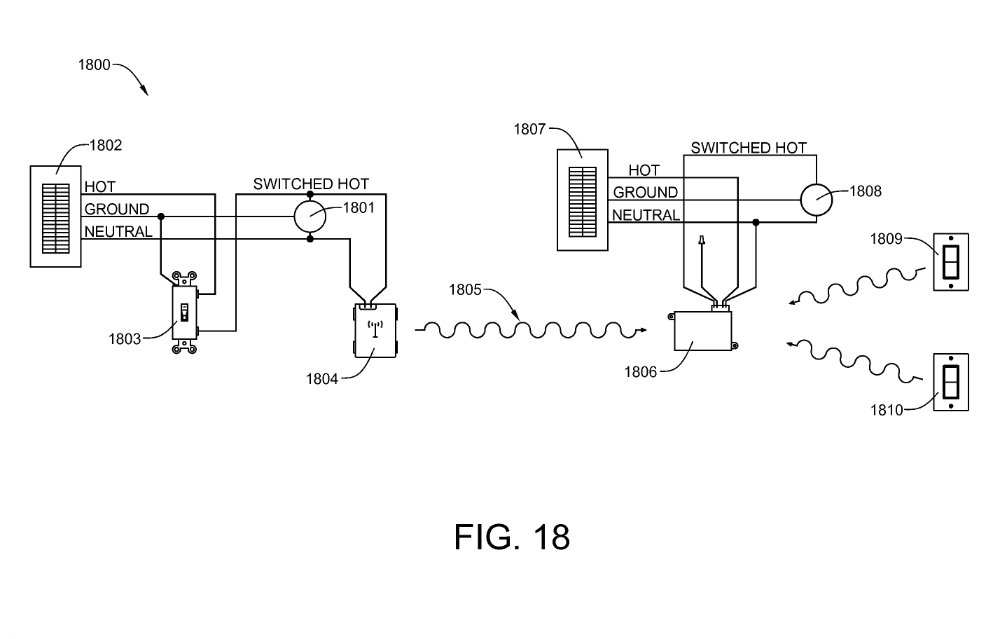

Referring now to FIG. 18, an electrical system 1800 includes a first load 1801 that is connected to a voltage source provided by a first circuit breaker panel 1802. The hot connection between the first circuit breaker panel 1802 and the first load 1801 is routed through a single-pole manual switch 1803. When a local sensor unit 1804 detects a voltage between the inputs of the first load 1801, it broadcasts a control signal 1805 (in this case, an “ON” control signal), which is received by a remote actuator unit (RAU) 1806 that is connected to a second voltage source provided by a second circuit breaker panel 1807. Upon receipt of the “ON” control signal 1805, the RAU 1806 switches on the power to a second load 1808. Likewise, when local sensor unit 1804 detects the absence of voltage between the inputs of the first load 1801, it broadcasts a control signal 1805 (in this case, an “OFF” control signal) which is received by the RAU 1806. Upon receipt of the “OFF” control signal 1805, the RAU 1806 switches off the power to the second load 1808. The second load 1808 can also be controlled by either of the first and second self-powered wireless sensors 1809 and 1810, respectively, each of which is capable of sending either an “ON” or “OFF” control signal to the RAU 1806.

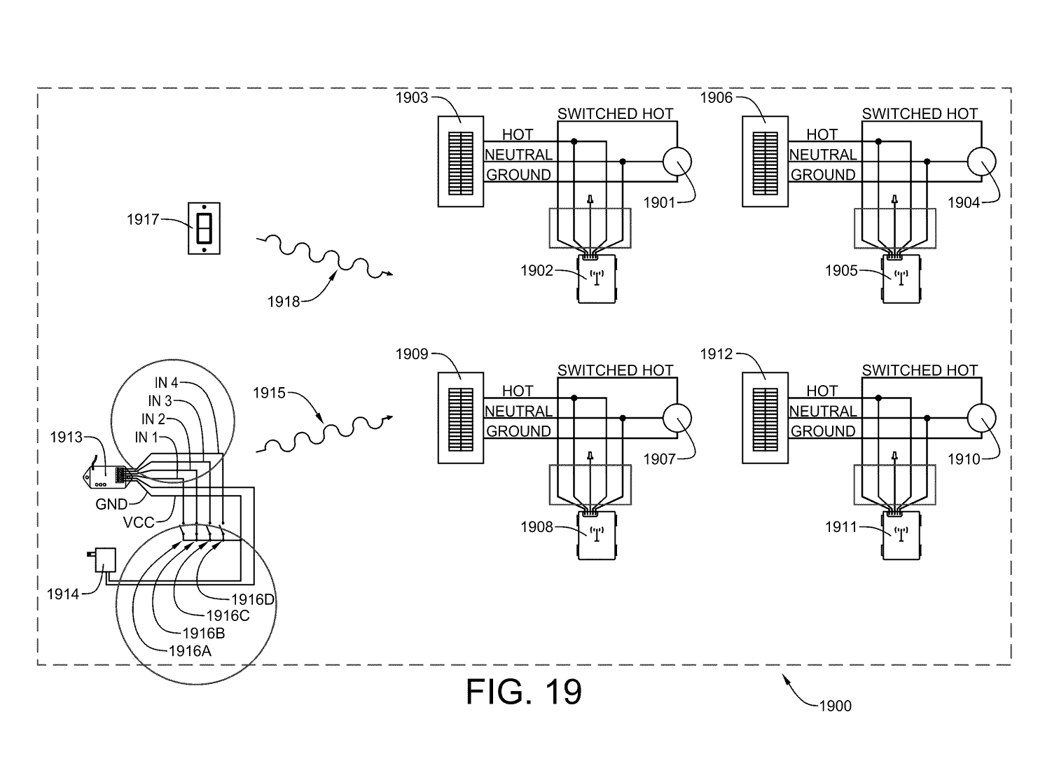

Referring now to FIG. 19, an electrical system 1900 includes a first electrical load 1901 that is connected via a first remote actuator unit (RAU) 1902 to a voltage source provided by first circuit breaker panel 1903. A second electrical load 1904 is connected via a second RAU 1905 to a voltage source provided by a second circuit breaker panel 1906. A third electrical load 1907 is connected via a third RAU 1908 to a voltage source provided by third circuit breaker panel 1909. A fourth electrical load 1910 is connected via a fourth RAU 1911 to a voltage source provided by fourth circuit breaker panel 1912. A four-channel local sensor unit (LSU) 1913, that is powered by a 120-volt AC adapter 914, transmits a control signal 1915 whenever the status of one of the four sensor switches 1916A, 1916B, 1916C or 1916D experiences a change in status. Associations have been created between sensor switch 1916A and RAU 1902; between sensor switch 1916B and RAU 1905; between sensor switch 1916C and RAU 1908 and between sensor switch 1916D and RAU 1911. Thus, when first sensor switch 1916A experiences a status change from “OFF” to “ON”, a “ON” control signal is sent by LSU 1913 that is received by the first, second, third and fourth RAUs 1902, 1905, 1908 and 1911, respectively. However, only the first RAU 1902 reacts to the receipt of the signal by switching on power from the first circuit breaker panel 1903 to the first load 1901. Likewise, when the third sensor switch 1916C experiences a status change from “ON” to “OFF”, an “OFF” control signal is sent by LSU 1913 that is received by all RAUs 1902, 1904, 1908 and 1911, with only the third RAU 1908 acting in response to the control signal by switching off power from the third circuit breaker panel 1909 to the third load 1907. The second and fourth RAUs 1905 and 1911, respectively, function similarly. Power to the first, second, third and fourth electrical loads 1901, 1904, 1907 and 1910 can also be switched on or off by means of a self-powered wireless sensor (SPWS) 1917, which transmits a wireless control signal 1918, and which can be programmed to activate or deactivate all four loads 1901, 1904, 1907 and 1910 simultaneously. Alternatively, separate SPWS can be provided to independently control each of the four loads 1901, 1904, 1907 and 1910.

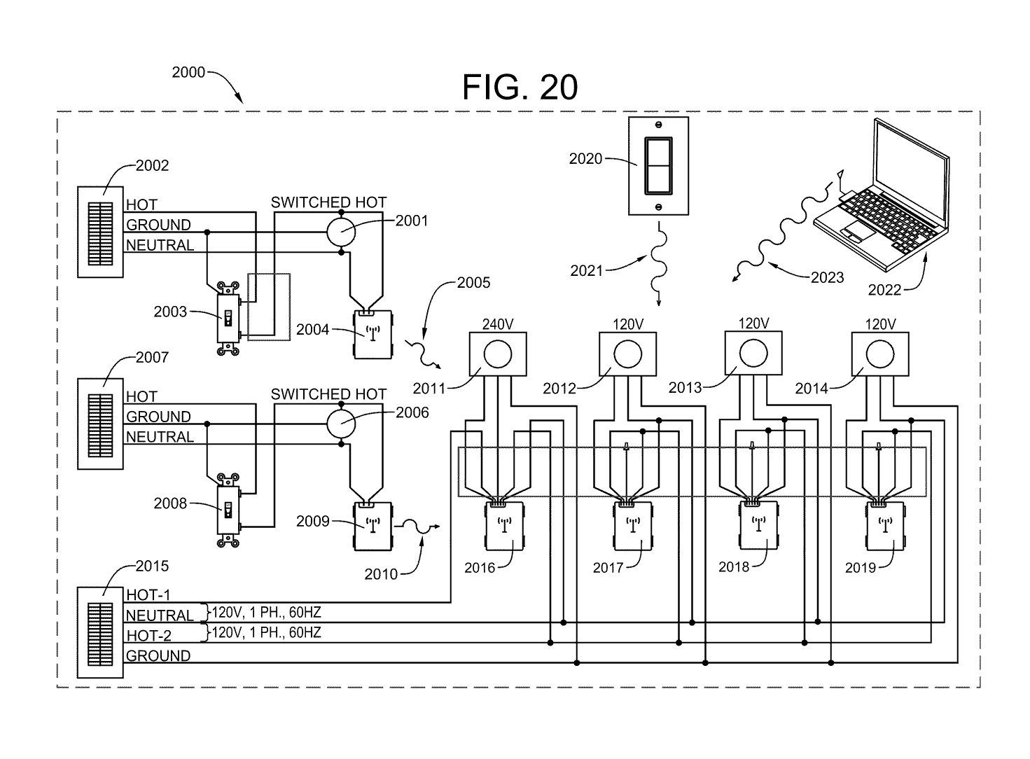

Referring now to FIG. 20, an electrical system 2000 includes a first electrical load 2001 that is connected to a voltage source provided by a first circuit breaker panel 2002. The hot connection between the second circuit breaker panel 2002 and the first load 2001 is routed through a single-pole manual switch 2003. When a first local sensor unit (LSU) 2004 detects a voltage between the inputs of the first load 2001, it broadcasts a control signal 2005 (in this case, an “ON” control signal). Conversely, when the first LSU 2004 detects the absence of voltage between the inputs of the first load 2001, it broadcasts a control signal 2005 (in this case, an “OFF” control signal). Likewise, a second electrical load 2006 is connected to a voltage source provided by a second circuit breaker panel 2007. The hot connection between the second circuit breaker panel 2007 and the second load 2006 is routed through a single-pole manual switch 2008. When a second LSU 2009 detects a voltage between the inputs of the second load 2006, it broadcasts a control signal 2010 (in this case, an “ON” control signal). Conversely, when the second LSU 2009 detects the absence of voltage between the inputs of the second load 2006, it broadcasts a control signal 2010 (in this case, an “OFF” control signal). In addition, each of four fan motors 2011, 2012, 2013, and 2014 is coupled to a voltage source provided by a third circuit breaker panel 2015 via its own remote actuator unit (RAU) 2016, 2017, 2018 and 2019, respectively. It will be noted that fan motor 2011 is a 240-volt unit, while fan motors 2012, 2013 and 2014 are 120-volt units. The electrical system of FIG. 20 also includes self-powered wireless sensor (SPWS) 2020, which is capable of independently transmitting either an “ON” or “OFF” control signal 2021. The electrical system of FIG. 20 also includes a computer system 2022 that is equipped with wireless communications capability and that is running a wireless commissioning system (WCS). By means of the WCS, associations are created between each of the RAUs 2016, 2017, 2018 and 2019 and at least one LSU (2004 and 2009) and/or the SPWS 2020 by transmitting wireless commissioning signals 2023. Thus, when a control signal transmitted by either an LSU 2004 or 2009 or by the SPWS 2020 is received by a RAU 2016, 2017, 2018 and 2019 for which an association has been formed with the transmitting LSU or SPWS, that RAU will either connect or disconnect power to the load.

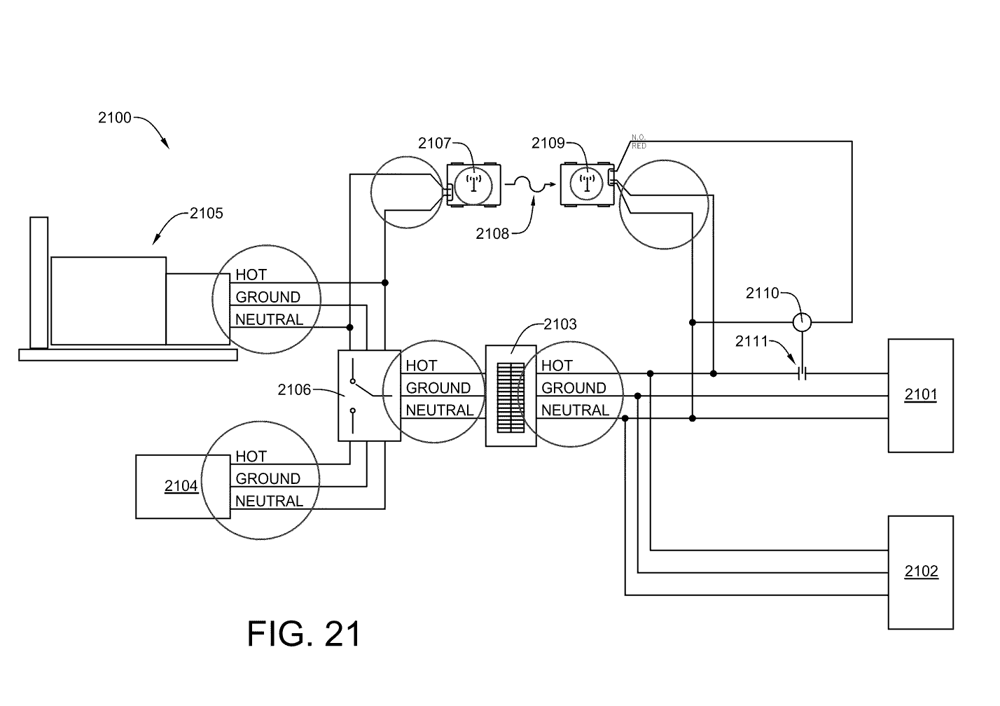

Referring now to FIG. 21, an electrical system 2100 includes a heavy electrical load 2101, as well as a light electrical load 2102. Both the heavy electrical load 2101 and the light electrical load 2102 are connected to a circuit breaker panel 2103, which derives its power from either the AC supply mains 2104 or a backup generator 2105, depending on the setting of a transfer switch 2106. The backup generator 2105 has sufficient output capacity to power the light electrical load 2102, but not heavy electrical load 2101 combined with the light electrical load 2102. The transfer switch 2106 is designed to automatically disconnect the AC supply mains 2104 and connect the backup generator 2105 if the AC supply mains 2104 fail. Although not shown, a generator starter circuit is also designed to activate when a failure of the AC supply mains 2104 is detected. Once the backup generator 2105 is started an SLT power sensor 2107 acting as a local sensor unit (LSU) detects the presence of voltage produced by the backup generator 2105. In response to this detection, the SLT power sensor 2107 transmits a control signal 2108, which is received by a relay receiver 2109 acting as a remote actuator unit (RAU). In response to the received control signal 2108, the relay receiver 2109 activates the coil 2110 of a relay 2111, which decouples the heavy electrical load 2101 from the circuit breaker panel 2103, thereby leaving only the light electrical load 2102 coupled to the backup generator 2105.

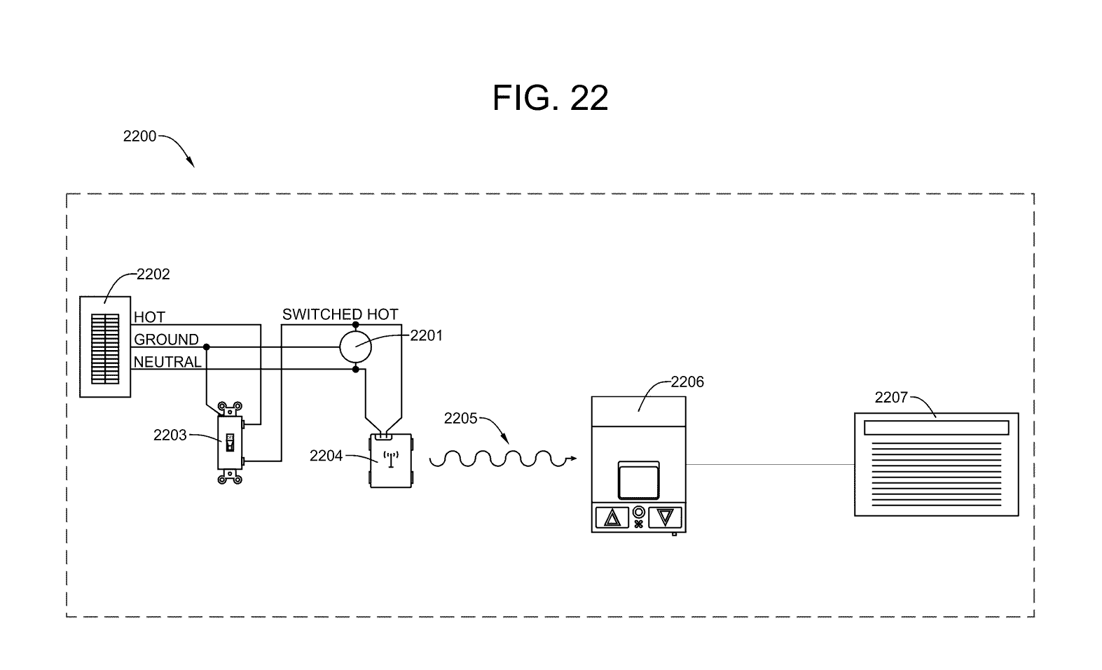

Referring now to FIG. 22, an electrical system 2200 includes a load 2201 (such as a lighting load that is switched on whenever a building is occupied) that is connected to a voltage source provided by a circuit breaker panel 2202. Although the hot connection between the first circuit breaker panel 2202 and the load 2201 is shown as being routed through a single-pole manual switch 2203, a combination of 3-way and/or 4-way switches could also be used to switch the load 2201. When a local sensor unit 2204 detects a voltage between the inputs of the load 2201, it broadcasts a control signal 2205 (in this case, an “ON” control signal), which is received by a thermostat incorporating wireless control 2206, which acts as a remote actuator unit (RAU). The thermostat 2206 controls the operation of a heating, ventilation and air conditioning (HVAC) unit 2207. Upon receipt of the “ON” control signal 2205, the thermostat 2206 activates the HVAC unit 2207 so that it operates in a mode consistent with building occupancy. On the other hand, when the local sensor unit 2204 detects the disappearance of voltage between the inputs of the load 2201, it broadcasts a control signal 2205 (in this case, an “OFF” control signal) which is received by the thermostat 2206. Upon receipt of the “OFF” control signal 2205, the thermostat 2206 causes the HVAC unit 2207 to revert to set-back settings, which may, for example, provide for the production of only sufficient heat to prevent water pipes within the building from freezing in cold weather.

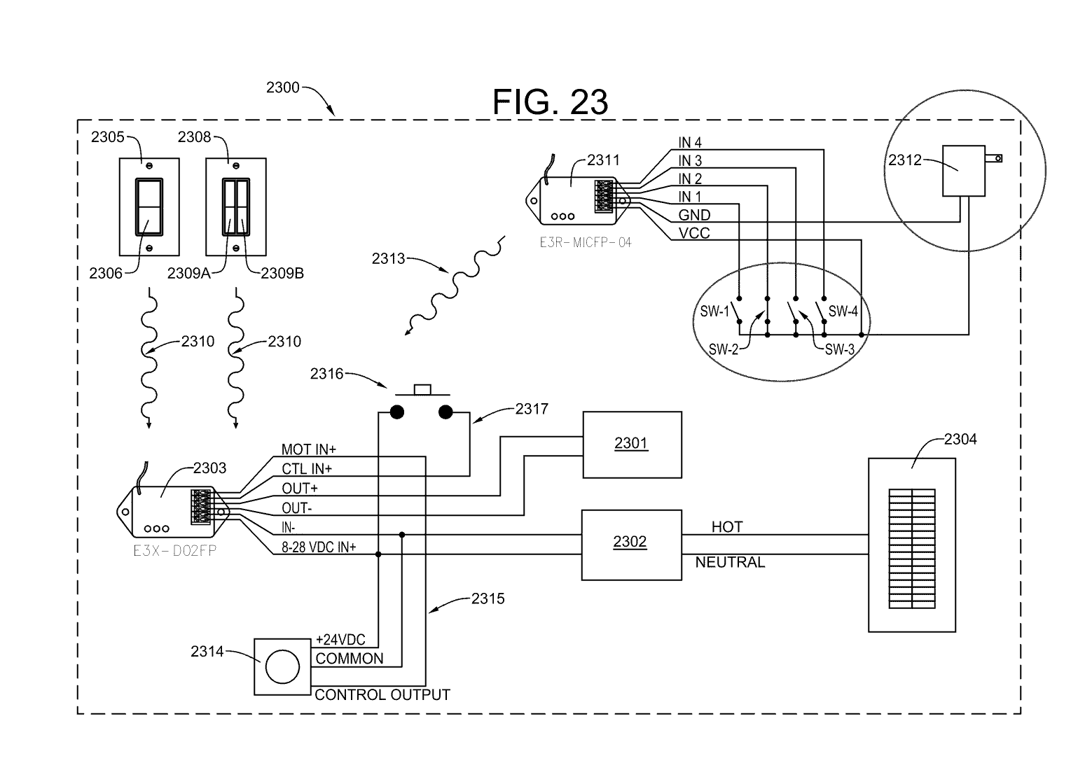

Referring now to FIG. 23, an electrical system 2300 includes a 24-volt DC dimmable light-emitting diode (LED) fixture 2301 that is connected to a 24-volt DC power supply 2302 via a remote actuator unit (RAU) 2303. The 24-volt DC power supply 2302 is connected to a circuit breaker panel 2304. The RAU 2303 is controllable by a first a first self-powered wireless sensor (SPWS) 2305 which has a single switch paddle 2306 and transmits a wireless control signal 2307, a second SPWS 2308 having a pair of switch paddles 2309A and 2309B that transmits a wireless control signal 2310, a four-channel local sensor unit (SLU) 2311 that is powered by a 120-volt AC adapter 2312 and that is capable of wirelessly controlling up to four RAUs by means of a wireless control signal 2313, a 24-volt DC sensor 2314 that can turn on the LED fixture 2301 by sending a hard-wired motion-detect signal 2315 to the RAU 2303, and a momentary contact switch 2316 that provides local control of the LED fixture 2301 via a hard-wired control signal 2317.

Although only several embodiments of the invention have been described herein, it should be obvious to those having ordinary skill in the art that changes and modifications may be made thereto without departing from the scope and the spirit of the invention as hereinafter claimed.

What is claimed is:

1. A wireless sensing and control system comprising:
at least one local sensor unit (LSU), said LSU is coupled to an electrical system, said LSU having at least one sensor for monitoring the electrical system, said LSU having a means for establishing associations between it and other system components, said LSU having a means for wireless communication with other system components, said LSU having a means for converting sensed status information to a control signal transmittable by said at least one wireless communication means; and
at least one remote actuator unit (RAU), said RAU is configured to respond to wireless signals received from at least one of the system's LSUs, said RAU having means for establishing associations between it and other system components, said RAU having a means for wireless communication with other system components, said RAU connected between an external load and an electrical power source, and said RAU having a means for modifying the connection between the electrical power source and the external load.

2. The wireless sensing and control system of claim 1, wherein modification of the connection between the external power source and the external load includes an action selected from the group consisting of turning on, turning off, modulating pulse width, varying output voltage of the external power source, varying the current emanating from the external power source, limiting startup inrush current at initial startup, and detecting the transition of a signal waveform from positive and negative.

3. The wireless sensing and control system of claim 1, wherein information contained in wireless signals received by a RAU from system LSUs is at least one factor which determines when said means for modifying is employed to modify the connection between the external power source and the external load.

4. The wireless sensing and control system of claim 1, wherein a RAU wirelessly transmits at least one status/acknowledgement signal whenever it receives a control signal from a system LSU, said at least one status/acknowledgement signal containing information about the state of the connection between the external power source and the external load.

5. The wireless sensing and control system of claim 1, wherein a RAU wirelessly transmits at least one status/acknowledgement signal whenever it determines that it should, based on an internal algorithm or procedure, said at least one status/acknowledgement signal containing information about the state of the connection between the external power source and the external load.

6. The wireless sensing and control system of claim 1, wherein a RAU has the ability to repeat or retransmit control signals which it receives.

7. The wireless sensing and control system of claim 1, wherein a RAU mounts adjacent an electrical wiring box.

8. The wireless sensing and control system of claim 1, which further comprises:
at least one self-powered wireless sensor (SPWS) having wireless communication means, means for establishing associations between it and other system components, at least one sensor, means for decoding sensor information, and means for transmitting sensor information.

9. The wireless sensing and control system of claim 8, wherein each SPWS is capable of sensing at least one physical condition selected from the group consisting of temperature, motion, force, humidity, light, sound, pressure and movement.

10. The wireless sensing and control system of claim 9, wherein an SPWS wirelessly transmits control signals when a physical condition it is sensing changes.

11. The wireless sensing and control system of claim 9, wherein an SPWS wirelessly transmits control signals when a physical condition it is sensing meets a pre-defined criterion.

12. The wireless sensing and control system of claim 9, wherein an SPWS wirelessly transmits control signals according to a pre-determined schedule, said schedule being selected from the group consisting of periodic, occasional, random, deterministic and cyclical schedule.

13. The wireless sensing and control system of claim 9, wherein an SPWS never wirelessly transmits control signals while a physical condition it is sensing remains unchanged.

14. The wireless sensing and control system of claim 9, wherein an SPWS only occasionally transmits control signals while a physical condition it is sensing remains unchanged.

15. The wireless sensing and control system of claim 9, wherein an SPWS wireless transmits control signals when caused to do so by a user.

16. The wireless sensing and control system of claim 8, wherein said local power source includes at least one device selected from the group consisting of energy storage devices and energy-harvesting devices.

17. The wireless sensing and control system of claim 16, wherein said energy storage devices are selected from the group consisting of voltaic cells, batteries, capacitors, and inductors, and energy-harvesting devices.

18. The wireless sensing and control system of claim 16, wherein said energy-harvesting devices are selected from the group consisting of photoelectric, piezoelectric, pyroelectric, thermoelectric, electrostatic, electrodynamic, magnetostatic, and magnetodynamic devices.

19. The wireless sensing and control system of claim 1, which further comprises:
a wireless commissioning system (WCS) having a wireless transceiver;
a computing device, and a software application that allows the user to identify, query, and program the other wireless devices over the wireless interface.

20. A wireless sensing and control system comprising:
a first voltage source;
a second voltage source;
at least one local sensor unit (LSU) coupled to an electrical circuit, said LSU having at least one sensor for monitoring operational status of the electrical circuit, means for system configuration programming, wireless communication means for broadcasting control signals in response to a monitored operational status of the electrical circuit, wherein said electrical circuit, said at least one sensor, and said wireless communication means are powered by said first voltage source; and
at least one remote actuator unit (RAU) configured to respond to wireless control signals received from at least one of the system's LSUs, said at least one RAU having means for system configuration programming, at least one wireless communication module selected from the second group consisting of wireless receivers and wireless transceivers, an external load having a connection to the second voltage source, and means for modifying the connection between the second voltage source and the external load, wherein said wireless communication module of the second group and said means for modifying are also powered by said second voltage source.
